(19) United States
(12) Patent Application Publication
(10) Pub. No.: US 2014/0103883 A1
(43) Pub. Date: Apr. 17, 2014

(54) POWER SUPPLY DEVICE OF VEHICLE

(71) Applicant: Noritake MITSUTANI, Toyota-shi (JP)

(72) Inventor: Noritake MITSUTANI, Toyota-shi (JP)

(73) Assignee: TOYOTA JIDOSHA KABUSHIKI KAISHA, Toyota-shi (JP)

(21) Appl. No.: 14/038,689

(22) Filed: Sep. 26, 2013

(30) Foreign Application Priority Data
Oct. 17, 2012 (JP) 2012-229595

(51) Int. Cl. B60L 11/18

(52) U.S. Cl. CPC B60L 11/1851
USPC 320/162

(57) ABSTRACT

A vehicle includes a first battery; a converter; a second battery connected to an electric load in parallel with the converter; a charging device charging the first battery or the second battery using an external power supply of the vehicle; an electrical leakage detection device connected to the first battery and detecting electrical leakage; and a control device, when the second battery is charged using the charging device, causing one of electrodes of the first battery and one of electrodes of the second battery to be connected to each other, and determining based on a detection result by the electrical leakage detection device whether electrical leakage occurs or not.

This nonprovisional application is based on Japanese Patent Application No. 2012-229595 filed on Oct. 17, 2012 with the Japan Patent Office, the entire contents of which are hereby incorporated by reference.

### BACKGROUND OF THE INVENTION

1. Field of the Invention

The present invention relates to a technique for detecting occurrence of electrical leakage without deteriorating components in a vehicle equipped with a plurality of power storage devices.

2. Description of the Background Art

Japanese Patent Laying-Open No. 2010-124535 discloses a vehicle including a main power storage device, a sub power storage device and an electrical leakage detector connected to the main power storage device, in which electrical leakage is detected using the electrical leakage detector during charging of each of the main power storage device and the sub power storage device.

In the vehicle disclosed in the above-described documents, the electrical leakage detector is connected to the main power storage device. Accordingly, when the sub power storage device is charged using an external power supply, the main power storage device is connected to a vehicle system, thereby connecting the electrical leakage detector to the vehicle system for detecting electrical leakage. When the main power storage device is connected to the vehicle system, however, a voltage is applied from the main power storage device to the components in the vehicle system. Consequently, deterioration of the components in the vehicle system may be facilitated.

### SUMMARY OF THE INVENTION

An object of the present invention is to provide a power supply device of a vehicle in which occurrence of electrical leakage is detected while suppressing deterioration of components in a vehicle system.

A power supply device of a vehicle according to an aspect of the present invention includes a first power storage device serving as a supply source of electric power to an electric load serving as a driving source of a vehicle; a converter converting a voltage of the first power storage device and supplying the converted voltage to the electric load; a second power storage device connected to the electric load in parallel with the converter and serving as a supply source of electric power; a charging device connected to the converter in parallel with the second power storage device and charging at least one of the first power storage device and the second power storage device using an external power supply of the vehicle; an electrical leakage detection device connected to the first power storage device and detecting electrical leakage; and a control device, when the second power storage device is charged using the charging device, causing one of electrodes of the first power storage device and one of electrodes of the second power storage device to be connected to each other, and determining based on a detection result by the electrical leakage detection device whether electrical leakage occurs or not.

Preferably, the power supply device of a vehicle further includes a first relay including a first switch provided on a first positive electrode line between the first power storage device and the converter, and a second switch provided on a first negative electrode line between the first power storage device and the converter, and a second relay including a third switch provided on a second positive electrode line between the second power storage device and the electric load, and a fourth switch provided on a second negative electrode line between the second power storage device and the electric load. When the second power storage device is charged using the charging device, the control device renders each of the first switch and the fourth switch conductive, and determines based on the detection result by the electrical leakage detection device whether electrical leakage occurs or not.

Further preferably, the power supply device of a vehicle further includes a diode provided on the second positive electrode line, permitting a current to flow from the second power storage device toward the electric load, and interrupting a current flowing from the electric load toward the second power storage device.

Further preferably, when the external power supply and the charging device are electrically connected to each other, the control device renders each of the first switch and the fourth switch conductive.

Further preferably, the power supply device of a vehicle further includes a third relay provided between the second power storage device and the charging device. When electrical leakage is detected, the control device shuts off each of the first relay, the second relay and the third relay.

Further preferably, the first power storage device is a secondary battery higher in output power density than the second power storage device. The second power storage device is a secondary battery higher in capacity density than the first power storage device.

According to the present invention, when the second power storage device is charged, one of the electrodes of the first power storage device and one of the electrodes of the second power storage device are connected to each other. Accordingly, it is suppressed that a voltage is applied from the first power storage device to the vehicle system including the converter and the electric load. Furthermore, it becomes possible to use the electrical leakage detection device to determine whether electrical leakage occurs or not in a high-voltage path extending from the first power storage device through the converter to the second power storage device. Therefore, it becomes possible to provide a power supply device of a vehicle in which occurrence of electrical leakage is detected while suppressing deterioration of the components in the vehicle system.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the configuration of a vehicle in the present embodiment.

FIG. 2 is a diagram showing the configuration of a B1 monitoring unit including an electrical leakage detection device.

FIG. 3 is a functional block diagram of a control device mounted in the vehicle in the present embodiment.

FIG. 4 is a flowchart illustrating a control structure of a program executed by the control device mounted in the vehicle in the present embodiment.

FIG. 5 is a diagram showing the range in which electrical leakage can be detected by the electrical leakage detection device during charging of the second battery.

### DESCRIPTION OF THE PREFERRED EMBODIMENTS

The embodiments of the present invention will be hereinafter described with reference to the accompanying drawings. In the following description, the same components are designated by the same reference characters. Names and functions thereof are also the same. Therefore, detailed description thereof will not be repeated.

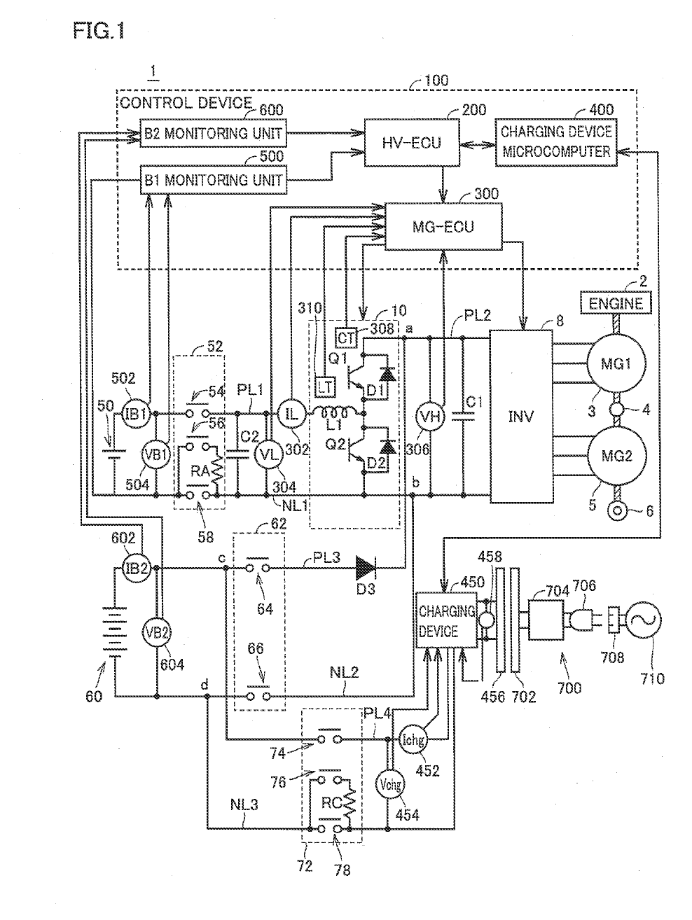

FIG. 1 is an entire block diagram of a vehicle in the present embodiment. Although the vehicle in the present embodiment will be for example described referring to a hybrid vehicle as an example that uses an engine and a motor generator as a driving source, it is not particularly limited to a hybrid vehicle using an engine and a motor generator as a driving source, but may be a hybrid vehicle or an electrically powered vehicle that uses only a motor generator as a driving source, for example.

Referring to FIG. 1, a hybrid vehicle (which will be simply referred to as a vehicle in the following description) includes an engine 2, a first motor generator (which will be hereinafter referred to as a first MG) 3, a power split device 4, a second motor generator (which will be hereinafter referred to as a second MG) 5, a wheel 6, an inverter 8, a converter 10, a first battery 50, a first system main relay (which will be hereinafter referred to as a first SMR) 52, a second battery 60, a second system main relay (which will be hereinafter referred to as a second SMR), a charging relay (which will be hereinafter referred to as a CHR) 72, a control device 100, current sensors 302, 452, 502, and 602, voltage sensors 304, 306, 454, 504, and 604, temperature sensors 308 and 310, a charging device 450, capacitors C1 and C2, a diode D3, positive electrode lines PL1, PL2, PL3, and PL4, and negative electrode lines NL1, NL2 and NL3.

The power supply device of vehicle 1 according to the present embodiment includes converter 10, first battery 50, first SMR 52, second battery 60, second SMR 62, CHR 72, control device 100, and charging device 450.

Vehicle 1 runs using engine 2 and motor generator MG2 as a motive power source. Power split device 3 is linked to engine 2, first MG 3 and second MG 5 for distributing motive power among them. Power split device 4 is, for example, formed of a planetary gear mechanism having three rotation shafts of a sun gear, a carrier and a ring gear. These three rotation shafts are connected to the rotation shafts of engine 2, first MG 3 and second MG 5, respectively. By inserting the crankshaft of engine 2 through the center of a hollow rotor of first MG 3, engine 4, first MG 3 and second MG 5 can mechanically be connected to power split device 4. Furthermore, the rotation shaft of second MG 5 is coupled to wheel 6 by a reduction gear or a differential gear that is not shown. First MG 3 is incorporated in vehicle 1 as a component that operates as a power generator driven by engine 2 and operates as an electric motor capable of starting engine 2. Second MG 5 is incorporated in vehicle 1 as an electric motor that drives wheel 6.

Engine 2 burns fuel such as gasoline, thereby allowing vehicle 1 to run in cooperation with second MG 5, or allowing vehicle 1 to run by itself.

Each of first battery 50 and second battery 60 is a chargeable and dischargeable power storage device which is, for example, a nickel-metal hydride or lithium-ion secondary battery. A large-capacity capacitor may be used in place of one or both of first battery 50 and second battery 60.

During driving of vehicle 1, first battery 50 supplies electric power to converter 10. During electric power regeneration, first battery 50 is supplied with electric power from converter 10 and thereby charged. First battery 50 and converter 10 are connected by positive electrode line PL1 and negative electrode line NL1. Positive electrode line PL1 has one end connected to the positive electrode terminal of first battery 50. Negative electrode line NL1 has one end connected to the negative electrode terminal of first battery 50. Positive electrode line PL1 has the other end connected to converter 10. Negative electrode line NL1 has the other end connected to inverter 8 through converter 10. First SMR 52 is provided at a prescribed position on each of positive electrode line PL1 and negative electrode line NL1 between first battery 50 and converter 10.

In response to the signal received from control device 100, first SMR 52 switches the state between first battery 50 and converter 10 from one state of a conductive state (ON state) and a non-conductive state (OFF state) to the other state.

When first SMR 52 is switched to an ON state, it becomes possible to transmit and receive electric power through positive electrode line PL1 and negative electrode line NL1 between first battery 50 and converter 10.

On the other hand, when first SMR 52 is switched to an OFF state, first battery 50 is disconnected from converter 10, thereby making it impossible to transmit and receive electric power between first battery 50 and converter 10.

First SMR 52 includes a first SMRB 54, a first SMRP 56, a first SMRG 58, and a limiting resistance RA. First SMRB 54 is provided on positive electrode line PL1, and serves as a switch for switching positive electrode line PL1 from at least one state of a conductive state and a non-conductive state to the other state. First SMRG 58 is provided on negative electrode line NL1, and serves as a switch for switching negative electrode line NL1 from at least one state of a conductive state and a non-conductive state to the other state. First SMRP 56 is a switch connected in series to limiting resistance RA. First SMRP 56 and limiting resistance RA are connected to negative electrode line NL1 in parallel with first SMRG 58.

When first SMR 52 is switched from an OFF state to an ON state, each of first SMRB 54 and first SMRP 56 is first switched from an OFF state to an ON state in order to prevent a large current from flowing immediately after first SMR 52 is switched to an ON state, and causing welding in the components in first SMR 52. Each of first SMRB 54 and first SMRP 56 is switched to an ON state, thereby generating an output current from first battery 50 to converter 10. At this time, limiting resistance RA connected in series to first SMRP 56 suppresses that an output current becomes excessive. Accordingly, a voltage VL is to gradually rise. When voltage VL rises and becomes almost equal to the voltage on first battery 50, first SMRP is switched to an OFF state while first SMRG 58 is switched to an ON state.

When first SMR 52 is switched from an ON state to an OFF state, each of first SMRB 54 and first SMRG 58 is switched from an ON state to an OFF state.

Second battery 60 is connected to the electric load (inverter 8, first MG 3 and second MG 5) in parallel with converter 10. The electric load and converter 10 are connected to each other by positive electrode line PL2 and negative electrode line NL1. Second battery 60 has a positive electrode terminal to which one end of positive electrode line PL3 is connected. Second battery 60 has a negative electrode terminal to which one end of negative electrode line NL2 is connected. Positive electrode line PL3 has the other end connected to a first connection node a located on positive electrode line PL2. Negative electrode line NL2 has the other end connected to a second connection node b located on negative electrode line NL1. Second SMR 62 is provided at a prescribed position on each of positive electrode line PL3 and negative electrode line NL2.

In response to the signal received from control device 100, second SMR 62 switches the state between second battery 60 and each of first connection node a and second connection node b from one state of a conductive state (ON state) and a non-conductive state (OFF state) to the other state.

When second SMR 62 is switched to an ON state, it becomes possible to transmit and receive electric power through positive electrode line PL3 and negative electrode line NL2 between second battery 60 and each of first connection node a and second connection node b, respectively.

On the other hand, when second SMR 62 is switched to an OFF state, second battery 60 is disconnected from first connection node a and second connection node b, thereby making it impossible to transmit and receive electric power between second battery 60 and each of first connection node a and second connection node b.

Second SMR 62 includes a second SMRB 64 and a second SMRG 66. Second SMRB 64 is provided on positive electrode line PL3, and serves as a switch for switching positive electrode line PL3 from at least one state of the conductive state and the non-conductive state to the other state. Second SMRG 66 is provided on negative electrode line NL2, and serves as a switch for switching negative electrode line NL2 from at least one state of the conductive state and the non-conductive state to the other state.

When second SMR 62 is switched from an OFF state to an ON state, each of second SMRB 64 and second SMRG 66 is switched to an ON state. Furthermore, when second SMR 62 is switched from an ON state to an OFF state, each of second SMRB 64 and second SMRG 66 is switched to an OFF state.

Diode D3 is provided between first connection node a and second SMRB 64. Diode D3 has an anode connected to second SMRB 64. Diode D3 has a cathode connected to first connection node a. Diode D3 interrupts the current from converter 10 or the electric load toward second battery 60, and permits the current to flow from second battery 60 toward converter 10 or the electric load.

First battery 50 and second battery 60 each are set to have a dischargeable capacity, for example, such that the maximum power permitted for the electric load (inverter 8 and motor generator MG2) can be output by simultaneously using these first battery 50 and second battery 60. This allows the vehicle to nm with the maximum power in the EV (Electric Vehicle) running during which engine 2 is not used.

When the electric power stored in second battery 60 has been consumed, the motive power of engine 2 is used in addition to the electric power of first battery 50, thereby allowing the vehicle to run with the maximum power without having to use second battery 60.

Also in the present embodiment, first battery 50 is a high output power-type battery that is higher in output power density than second battery 60. On the other hand, second battery 60 is a high capacity-type battery higher in capacity density than first battery 50. Furthermore, in the present embodiment, second battery 60 is a power storage device having a voltage higher than that of first battery 50.

Based on an instruction signal received from a MG-ECU 300, converter 10 raises the voltage level of the electric power supplied from first battery 50 to a target level, and outputs the voltage raised to the target level to positive electrode line PL2. Furthermore, based on the instruction signal received from MG-ECU 300, converter 10 lowers the voltage level of the regenerative electric power supplied from inverter 8 through positive electrode line PL2 or the voltage level of the charge power supplied from second battery 60 or charging device 450 through positive electrode lines PL3 and PL2 to the voltage level of first battery 50, and then charges first battery 50. Furthermore, when converter 10 receives an instruction signal instructing to stop the operation from MG-ECU 300, it stops the switching operation. Furthermore, when converter 10 receives an instruction signal instructing to switch the upper arm into an ON state from MG-ECU 300, it switches the upper arm and the lower arm included in converter 10 into an ON state and an OFF state, respectively, and holds these arms in their respective states.

Converter 10 includes power semiconductor switching elements (which will be simply referred to as a switching element in the following description) Q1 and Q2, diodes D1 and D2, and a reactor L1.

Although an IGBT (Insulated Gate Bipolar Transistor) is applied as each of switching elements Q1 and Q2 in the present embodiment, any switching element is applicable as long as it can be controlled to be on/off by an instruction signal. For example, a MOSFET (Metal Oxide Semiconductor Field Effect Transistor), a bipolar transistor or the like is also applicable.

Switching elements Q1 and Q2 are connected in series between positive electrode line PL2 and negative electrode line NL1. Diodes D1 and D2 are connected in anti-parallel to switching elements Q1 and Q2, respectively. Reactor L1 has one end connected to the connection node between switching elements Q1 and Q2, and the other end connected to positive electrode line PL1. Switching element Q1 corresponds to an upper arm of converter 10, and switching element Q2 corresponds to a lower arm of converter 10.

Converter 10 is formed of a chopper circuit. Based on the instruction signal received from MG-ECU 300, converter 10 raises the voltage on positive electrode line PL1 using reactor L1, and outputs the raised voltage to positive electrode line PL2.

At this time, MG-ECU 300 controls the ratio between the on-period and the off-period (duty) of switching element Q1 and/or switching element Q2, thereby controlling the raising ratio of the output voltage from first battery 50.

On the other hand, based on the instruction signal received from MG-ECU 300, converter 10 lowers the voltage on positive electrode line PL2, and outputs the lowered voltage to positive electrode line PL1.

At this time, MG-ECU 300 controls the ratio between the on-period and the off-period (duty) of switching element Q1 and/or switching element Q2, thereby controlling the lowering ratio of the voltage on positive electrode line PL2.

Capacitor C1 is connected between positive electrode line PL2 and negative electrode line NL1, and smoothes the voltage variation between positive electrode line PL2 and negative electrode line NL1. Capacitor C2 is connected between positive electrode line PL1 and negative electrode line NL1, and smoothes the voltage variation between positive electrode line PL1 and negative electrode line NL1.

During driving of first MG 3, based on the instruction signal received from MG-ECU 300, inverter 8 converts the direct-current (DC) voltage from positive electrode line PL2 into an three-phase alternating-current (AC) voltage, and outputs the converted AC voltage to first MG 3.

Furthermore, during power generation of first MG 3, based on the instruction signal received from MG-ECU 300, inverter 8 converts the three-phase AC voltage generated by first MG 3 using the motive power from engine 2 into a DC voltage, and outputs the converted DC voltage to positive electrode line PL2.

Furthermore, during the EV running, based on the instruction signal received from MG-ECU 300, inverter 8 converts the DC voltage from positive electrode line PL2 into a three-phase AC voltage, and outputs the converted AC voltage to second MG 5.

Furthermore, during regenerative braking of vehicle 1, based on the instruction signal received from MG-ECU 300, inverter 8 converts the three-phase AC voltage generated by second MG 5 with the rotating force input from wheel 6 into a DC voltage, and outputs the converted DC voltage to positive electrode line PL2.

Each of first MG 3 and second MG 5 is a three-phase AC rotating electric machine, and is formed of a three-phase AC synchronous electric motor generator, for example. First MG 3 outputs the three-phase AC voltage generated using the motive power of engine 2 to inverter 8. Furthermore, first MG 3 is driven by inverter 8 at the start of engine 2, to crank engine 2.

Second MG 5 is driven by inverter 8 to generate driving force for driving vehicle 1. Furthermore, during regenerative braking of vehicle 1, second MG 5 outputs the three-phase AC voltage generated using the rotating force received from wheel 6 to inverter 8.

Current sensor 302 detects a current IL flowing through reactor L1 of converter 10, and outputs the current to MG-ECU 300. Voltage sensor 304 detects a voltage VL across the terminals of capacitor C2, and outputs the voltage to MG-ECU 300. Voltage sensor 306 detects a voltage VH across the terminals of capacitor C1, and outputs the voltage to MG-ECU 300.

Temperature sensor 308 detects a temperature CT of converter 10 (which will be hereinafter referred to as a converter temperature), and outputs the detected converter temperature CT to MG-ECU 300. Converter temperature CT is, for example, a temperature of the component forming converter 10, such as switching element Q1 or Q2, other than reactor L1.

Temperature sensor 310 detects a temperature LT of reactor L1 (which will be hereinafter referred to as a reactor temperature), and outputs the detected reactor temperature LT to MG-ECU 300.

Current sensor 452 detects a current Ichg flowing through positive electrode line PL4, and outputs the detected current to charging device 450. Voltage sensor 454 detects a voltage Vchg between positive electrode line PLA and negative electrode line NL3, and outputs the detected voltage to charging device 450. Voltage sensor 458 detects an AC voltage VAC input into charging device 450, and outputs the detected voltage to charging device 450. Charging device 450 outputs the received detection result to control device 100. In addition, current sensor 452 and voltage sensors 454 and 458 may directly output the detection result to control device 100 in place of charging device 450.

Current sensor 502 detects a current IB1 flowing through positive electrode line PL1, and outputs the detected current to a B1 monitoring unit 500. Voltage sensor 504 detects a voltage VB1 of first battery 50, and outputs the detected voltage to B1 monitoring unit 500.

Current sensor 602 detects a current IB2 flowing through positive electrode line PL3, and outputs the detected current to a B2 monitoring unit 600. Voltage sensor 604 detects a voltage VB2 of second battery 60, and outputs the detected voltage to B2 monitoring unit 600.

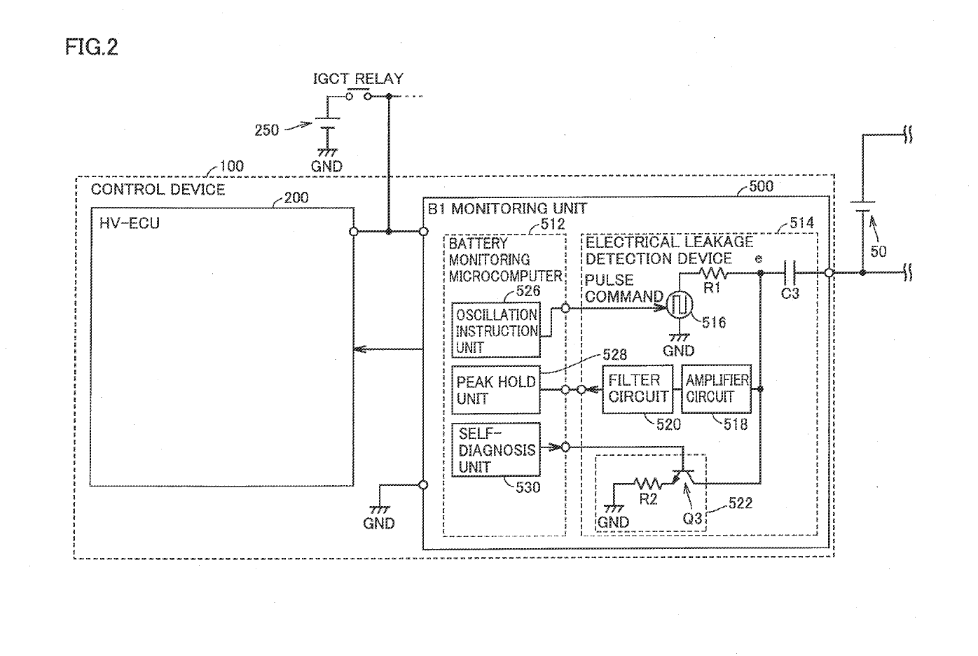

An auxiliary battery (see FIG. 2) is connected to positive electrode line PL1 and negative electrode line NL1 through a DC/DC converter that is not shown. The DC/DC converter lowers the DC voltage on positive electrode line PL1 in response to the signal received from control device 100, and charges the auxiliary battery. The auxiliary battery supplies electric power to the auxiliary machinery (not shown) mounted in vehicle 1. The auxiliary machinery is, for example, a headlight, a clock, an audio instrument, various types of ECUs and the like, but the type of this auxiliary machinery is not limited. The auxiliary battery is a chargeable and dischargeable power storage device, and for example, a lead acid battery.

Charging device 450 is connected to converter 10 in parallel with second battery 60. Charging device 450 has a positive electrode terminal connected to one end of positive electrode line PL4. Charging device 450 has a negative electrode terminal connected to one end of negative electrode line NL3. Positive electrode line PL4 has the other end connected to a third connection node c located on positive electrode line PL3. Negative electrode line NL3 has the other end connected to a fourth connection node d located on negative electrode line NL2.

In response to the instruction signal received from control device 100, charging device 450 uses the electric power supplied from a power supply 710 external to vehicle 1 (which will be referred to as an external power supply in the following description) to charge at least one of first battery 50 and second battery 60 or to stop the charging.

An inlet 456 is connected to charging device 450. Inlet 456 is provided on the side portion of vehicle 1, and shaped such that it can be connected to a connector 702 provided at one end of charging cable 700. Charging cable 700 has the other end provided with a plug 706, to which a receptacle 708 provided in external power supply 710 is connected.

External power supply 710 is an AC power supply, for example. The AC power supply is a commercial power supply supplied to a house from an electric power company, for example.

When inlet 456 and external power supply 710 are connected by charging cable 700, it becomes possible to supply the AC power of external power supply 710 to charging device 450. The AC power supplied from external power supply 710 is converted into a DC power by charging device 450, and output to positive electrode line PL4 and negative electrode line NL3.

Connector 702 is provided with a switch. When connector 702 is connected to inlet 456, the switch is closed. At this time, the signal indicating that the switch is closed is transmitted from the switch to control device 100. Control device 100 receives the signal indicating that the switch is closed, thereby determining that connector 702 is connected to inlet 456. In addition, the switch is opened and closed in coordination with the limitation member limiting the position of connector 702 in the state where this switch is connected to inlet 456.

Plug 706 is shaped such that it can be connected to receptacle 708 provided in a house. AC power is supplied to receptacle 708 from external power supply 710.

Charging cable 700 further includes a CCLD (Charging Circuit Interrupt Device) 704 in addition to connector 702 and plug 706.

CCID 704 has a relay and a control pilot circuit. In the state where the relay is opened, the path through which the electric power is supplied from external power supply 710 to inlet 456 is interrupted. In the state where the relay is closed, it becomes possible to supply electric power from external power supply 710 to inlet 456. The state of the relay is controlled by control device 100 in the state where connector 702 is connected to inlet 456.

In the state where plug 706 is connected to receptacle 708 and connector 702 is connected to inlet 456, the control pilot circuit sends a pilot signal (square wave signal) CPLT to a control pilot line. Pilot signal CPLT is changed periodically by a transmitter provided within the control pilot circuit.

When plug 706 is connected to receptacle 708 and connector 702 is connected to inlet 456, the control pilot circuit generates pilot signal CPLT with a predetermined pulse width (duty cycle). The pulse width of pilot signal CPLT is determined for each type of charging cable.

Generated pilot signal CPLT is transmitted to a HV-ECU 200. Pilot signal CPLT may be transmitted from CCID 704 through connector 702, charging device 450 and a charging device microcomputer 400 to HV-ECU 200, for example. HV-ECU 200 determines the current capacity that can be supplied through charging cable 700 to vehicle 1 based on the pulse width of received pilot signal CPLT.

CHR 72 is provided on positive electrode line PL4 and negative electrode line NL3. In response to the signal received from control device 100, CHR 72 switches the state between charging device 450 and each of third connection node c and fourth connection node d from at least one state of the conductive state (ON state) and the interrupted state (OFF state) to the other state.

When CHR 72 is switched to an ON state in the state where inlet 456 and external power supply 710 are connected by charging cable 700, it becomes possible to output the electric power supplied from external power supply 710 through inlet 456 and charging device 450 to positive electrode line PL4 and negative electrode line NL3. When CHR 72 is switched to an OFF state, the electric power becomes interrupted between the positive electrode terminal and the negative electrode terminal in charging device 450, and third connection node c and fourth connection node d, respectively.

CHR 72 has the same configuration as that of first SMR 52. In other words, the configuration corresponding to that of CHR 72 is as follows: that is, first battery 50 in the configuration of first SMR 52 described above is replaced with charging device 450, and also, first SMRB 54, first SMRP 56, first SMRG 58, and limiting resistance RA are replaced with CHRB 74, CHRP 76, CHRG 78, and limiting resistance RC, respectively.

When CIR 72 is switched from an OFF state to an ON state, each of CHRB 74 and CHRP 76 is switched from an OFF state to an ON state. Then, CHRP 76 is switched from an ON state to an OFF state while CHRG 78 is switched from an OFF state to an ON state.

Control device 100 generates an instruction signal for controlling inverter 8, converter 10, first SMR 52, second SMR 62, CHR 72, and charging device 450, and outputs the generated instruction signal to the devices to be controlled. Control device 100 includes HV-ECU 200, MG-ECU 300, charging device microcomputer 400, B1 monitoring unit 500, and B2 monitoring unit 600.

B1 monitoring unit 500 receives a detection value of current IB1 from current sensor 502, and a detection value of voltage VB1 from voltage sensor 504. B1 monitoring unit 500 transmits these detection values to HV-ECU 200. Furthermore, B1 monitoring unit 500, for example, may calculate an SOC (State Of Charge) showing the remaining capacity of first battery 50 based on these detection values, and transmit the calculated SOC to HV-ECU 200. For example, the SOC is defined as 100% when the power storage device is in a fully-charged state, and defined as 0% when the power storage device is in a completely discharged state. In addition, since the remaining capacity can be calculated by various known methods using the voltage and the charging and discharge currents of the power storage device, the temperature of the power storage device, and the like, detailed description thereof will not be given. In the following description, the SOC of first battery 50 will be referred to as an SOC1, and the SOC of second battery 60 will be referred to as an SOC2.

B1 monitoring unit 500 may calculate a limit value Win1 of the charge power of first battery 50 (which will be hereinafter simply referred to as Win1) and a limit value Wout1 of the discharge power of first battery 50 (which will be hereinafter simply referred to as Wout1), for example, based on SOC1, current IB1, voltage VB1, the battery temperature of first battery 50, the outside air temperature or the like, and may transmit the calculated Win and Wout1 to HV-ECU 200. It is to be noted that SOC1, Win1 and Wout1 may be calculated by HV-ECU 200, for example.

Furthermore, B1 monitoring unit 500 includes an electrical leakage detection device (see FIG. 2). The electrical leakage detection device is connected to negative electrode line NL1 on the negative electrode terminal side of first battery 50. The configuration and the operation of the electrical leakage detection device will be described later.

B2 monitoring unit 600 receives a detection value of current IB2 from current sensor 602, and a detection value of voltage VB2 from voltage sensor 604. B2 monitoring unit 600 transmits these detection values to HV-ECU 200. Furthermore, B2 monitoring unit 600, for example, may calculate SOC2 from these detection values and transmit the calculated SOC2 to HV-ECU 200.

B2 monitoring unit 600 may calculate a limit value Win2 of the charge power of second battery 60 (which will be hereinafter simply referred to as Win2) and a limit value Wout2 of the discharge power of second battery 60 (which will be hereinafter simply referred to as Wout2), for example, based on SOC2, current IB2, voltage VB2, the battery temperature of second battery 60, the outside air temperature or the like, and may transmit the calculated Win2 and Wout2 to HV-ECU 200. It is to be noted that SOC2, Win2 and Wout2 may be calculated by HV-ECU 200, for example.

Based on the information of first battery 50 and second battery 60 received from B1 monitoring unit 500 and B2 monitoring unit 600, respectively, HV-ECU 200 calculates a control request amount CHPW of charging device 450 (that is, the requested amount of the charge power from charging device 450) and a control request amount CHPWCNV of converter 10 (that is, the requested amount of the electric power to be supplied from converter 10 to first battery 50). HV-ECU 200 transmits the calculated control request amount CHPW of charging device 450 to charging device microcomputer 400. HV-ECU 200 transmits the calculated control request amount CHPWCNV of converter 10 to MG-ECU 300.

MG-ECU 300 generates an instruction signal for controlling converter 10 based on control request amount CHPWCNV of converter 10 received from HV-ECU 200, and transmits the generated signal to converter 10.

Charging device microcomputer 400 generates an instruction signal for controlling charging device 450 based on control request amount CHPW received from HV-ECU 200, and transmits the generated instruction signal to charging device 450.

In the present embodiment, when vehicle 1 and external power supply 710 are coupled to each other by charging cable 700, control device 100 switches CHR 72 from an OFF state to an ON state, and charges first battery 50 or second battery 60 using charging device 450.

FIG. 2 shows a detailed configuration and operation of B1 monitoring unit 500. As shown in FIG. 2, B1 monitoring unit 500 includes a battery monitoring microcomputer 512 and an electrical leakage detection device 514. It is to be noted that the configurations shown in FIG. 1 other than first battery 50 will be omitted. Furthermore, the ground (GND) shown in FIG. 2 corresponds to a vehicle body in vehicle 1.

Electrical leakage detection device 514 includes an oscillation circuit 516 serving as a signal generation unit, an amplifier circuit 518, a filter circuit 520, a self-diagnostic circuit 522, a detection resistance R1, and a capacitor C3 serving as a coupling capacitor.

Oscillation circuit 516 is connected to one end of detection resistance R1. Based on the pulse command from battery monitoring microcomputer 512, oscillation circuit 516 outputs a pulse signal that changes at a predetermined frequency to a connection node with one end of detection resistance R1. Detection resistance R1 has the other end connected to one end of capacitor C3. In other words, detection resistance R1 is connected between oscillation circuit 516 and capacitor C3. Capacitor C3 has the other end connected to negative electrode line NL1.

Amplifier circuit 518 and self-diagnostic circuit 522 are connected to a connection node e between the other end of detection resistance R1 and one end of capacitor C3. Amplifier circuit 518 amplifies the pulse signal from connection node e, and outputs the amplified pulse signal to filter circuit 520. Filter circuit 520 is for example a band-pass filter, and extracts a pulse signal in a prescribed frequency band from the pulse signal input from amplifier circuit 518, and then outputs the extracted pulse signal to battery monitoring microcomputer 512. The prescribed frequency band is set in accordance with the frequency of the pulse signal output from oscillation circuit 516, for example.

Self-diagnostic circuit 522 includes a switching element Q3 and a resistance R2 for self-diagnosis. Switching element Q3 is switched from one of the conductive state and the non-conductive state to the other state based on the instruction signal from battery monitoring microcomputer 512.

Battery monitoring microcomputer 512 controls oscillation circuit 516 and self-diagnostic circuit 522. Furthermore, battery monitoring microcomputer 512 detects a voltage of the signal output from filter circuit 520, and detects a decrease in an insulation resistance Ri based on the detected voltage.

Battery monitoring microcomputer 512 includes an oscillation instruction unit 526, a peak hold unit 528 and a self-diagnosis unit 530.

Oscillation instruction unit 526 gives an instruction to oscillation circuit 516 to generate a pulse signal. Peak hold unit 528 detects a peak voltage (the maximum voltage) in a prescribed sampling period of the pulse signal output from filter circuit 520, and transmits the detected peak voltage to HV-ECU 200 as a peak value Vp. The prescribed sampling period is not particularly limited as long as it is a period in which at least the voltage corresponding to the peak of the pulse signal can be detected.

When performing a self-diagnosis process, self-diagnosis unit 530 transmits an instruction signal to switching element Q3 of self-diagnostic circuit 522. Furthermore, when performing a self-diagnosis process, self-diagnosis unit 530 transmits a signal to HV-ECU 200 showing that the self-diagnosis process is being performed. For example, self-diagnostic circuit 522 may perform a self-diagnosis process based on the instruction signal received from HV-ECU 200, or may perform a self-diagnosis process for each prescribed time period.

HV-ECU 200 determines based on peak value Vp received from battery monitoring microcomputer 512 whether electrical leakage is caused or not by a decrease in insulation resistance Ri.

In the case of a normal state where electrical leakage does not occur, insulation resistance Ri>>detection resistance R1. Accordingly, the peak voltage detected in peak hold unit 528 becomes equal to a peak voltage of the voltage of the signal output from oscillation circuit 516. On the other hand, when insulation resistance Ri decreases, voltage division occurs, and the peak voltage detected in peak hold unit 528 decreases as compared with that in the normal state. Accordingly, when peak value Vp is smaller than a threshold value Vp(0), HV-ECU 200 determines that electrical leakage occurs. It is to be noted that threshold value Vp(0) is for example a predetermined value, and also smaller than the peak voltage in the case of the normal state where at least electrical leakage does not occur.

Furthermore, when receiving the signal from battery monitoring microcomputer 512 showing that the self-diagnosis process is being performed, HV-ECU 200 determines that electrical leakage detection device 514 is in a normal state if peak value Vp falls within a prescribed range, and determines that electrical leakage detection device 514 is in an abnormal state if peak value Vp is beyond a prescribed range. The prescribed range corresponds to a range set based on the resistance value of resistance R2 for self-diagnosis. The upper limit value of the prescribed range is smaller than the peak voltage in the case of the normal state where at least electrical leakage does not occur.

Although description has been given in the present embodiment with regard to the configuration in which HV-ECU 200 determines whether electrical leakage occurs or not and whether electrical leakage detection device 514 is in a normal state or not, the determination may be made by battery monitoring microcomputer 512, for example.

Furthermore, HV-ECU 200 and B1 monitoring unit 500 each are connected to auxiliary battery 250 (for example, DC 12V) through an IGCT relay. The IGCT relay is switched from an OFF state to an ON state, for example, when the system of vehicle 1 is started. When the IGCT relay is switched to an ON state, the electric power of auxiliary battery 250 is supplied to electrical devices such as HV-ECU 200 and B1 monitoring unit 500 required for allowing vehicle 1 to run. In addition, auxiliary battery 250 and HV-ECU 200 are connected through a power supply control IC that is not shown. When the IGCT relay is in an OFF state, power supply control IC converts the electric power of auxiliary battery 250 into an internal power supply voltage (for example, DC 5V), and supplies the converted voltage to HV-ECU 200.

The present embodiment is characterized in that, when second battery 60 is charged using charging device 450, control device 100 mounted in vehicle 1 having the configuration as described above causes one of electrodes of first battery 50 and one of electrodes of second battery 60 to be connected to each other, and also determines based on the detection result by electrical leakage detection device 514 whether electrical leakage occurs or not. In the present embodiment, each of first SMRB 54 and second SMRG 66 is rendered conductive, thereby connecting the positive electrode of first battery 50 and the negative electrode of second battery 60 to each other.

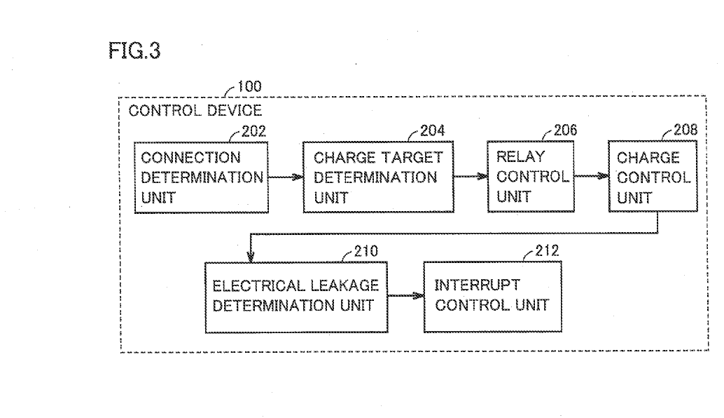

FIG. 3 shows a functional block diagram of control device 100 mounted in vehicle 1 according to the present embodiment. Control device 100 includes a connection determination unit 202, a charge target determination unit 204, a relay control unit 206, a charge control unit 208, an electrical leakage determination unit 210, and an interrupt control unit 212.

In addition, the process in each of connection determination unit 202, charge target determination unit 204, relay control unit 206, charge control unit 208, electrical leakage determination unit 210, and interrupt control unit 212 may be performed by at least one of HV-ECU 200, MG-ECU 300, charging device microcomputer 400, and BJ monitoring units 500. Also, for example, HV-ECU 200 may perform all of the above-described processes.

Connection determination unit 202 determines whether connector 702 is connected to inlet 456 or not. For example, when receiving a signal from connector 702 showing that the switch is closed, connection determination unit 202 may determine that connector 702 is connected to inlet 456, or when receiving pilot signal CPLT from charging cable 700, connection determination unit 202 may determine that connector 702 is connected to inlet 456.

For example, when it is determined that connector 702 is connected to inlet 456, connection determination unit 202 may switch a connection determination flag from an OFF state to an ON state. Alternatively, for example, when it is determined that connector 702 is disconnected from inlet 456, connection determination unit 202 may switch the connection determination flag from an ON state to an OFF state.

When connection determination unit 202 determines that connector 702 is connected, charge target determination unit 204 determines whether second battery 60 is a target to be charged. For example, when the SOC of second battery 60 is lower than the threshold value used for determining that charging is required, charge target determination unit 204 may determine that second battery 60 is a target to be charged. For example, when the connection determination flag is in an ON state, charge target determination unit 204 may determine whether or not second battery 60 is a target to be charged. When second battery 60 is a target to be charged, charge target determination unit 204 may switch a charge target flag to an ON state.

When connection determination unit 202 determines that connector 702 is connected to inlet 456, and when charge target determination unit 204 determines that the target to be charged is second battery 60, relay control unit 206 switches each of first SMRB 54, second SMRG 66 and CHR 72 to an ON state. In addition, for example, when each of the connection determination flag and the charge target flag is in an ON state, relay control unit 206 may switch each of first SMRB 54, second SMRG 66 and CHR 72 to an ON state.

After relay control unit 206 switches each of first SMRB 54, second SMROG 66 and CHR 72 to an ON state, charge control unit 208 controls charging device 450 such that the charge power from charging device 450 is supplied to second battery 60. When the SOC of second battery 60 is equal to or greater than the threshold value used for determining that second battery 60 is in a fully-charged state, charge control unit 208 ends charging of second battery 60.

Electrical leakage determination unit 210 determines whether electrical leakage occurs or not in any portion of the path electrically connected to electrical leakage detection device 514 during charging of second battery 60 using charging device 450 after each of first SMRB 54, second SMRG 66 and CHR 72 is switched to an ON state by relay control unit 206.

Specifically, electrical leakage determination unit 210 controls oscillation circuit 516 such that a pulse signal is output. Also, when peak value Vp (a peak voltage) detected in peak hold unit 528 becomes smaller than threshold value Vp(0), electrical leakage determination unit 210 determines that electrical leakage occurs in any portion of the path electrically connected to electrical leakage detection device 514.

For example, when it is determined that electrical leakage occurs, electrical leakage determination unit 210 may set the electrical leakage determination flag to an ON state.

When electrical leakage determination unit 210 determines that electrical leakage occurs, when connection determination unit 202 determines that connector 702 is disconnected, or when charge control unit 208 ends charging of second battery 60, interrupt control unit 212 switches each of first SMRB 54, second SMRG 66 and CHR 72 to an OFF state. It is to be noted that interrupt control unit 212 may switch only CHR 72 to an OFF state in stead of switching each of first SMRB 54, second SMRG 66 and CHR 72 to an OFF state.

In the present embodiment, connection determination unit 202, charge target determination unit 204, relay control unit 206, electrical leakage determination unit 210, and interrupt control unit 212 each are described as functioning as software implemented by the CPU executing the program stored in the memory, but may be implemented by hardware. It is to be noted that such a program is recorded on a storage medium which is mounted in vehicle 1.

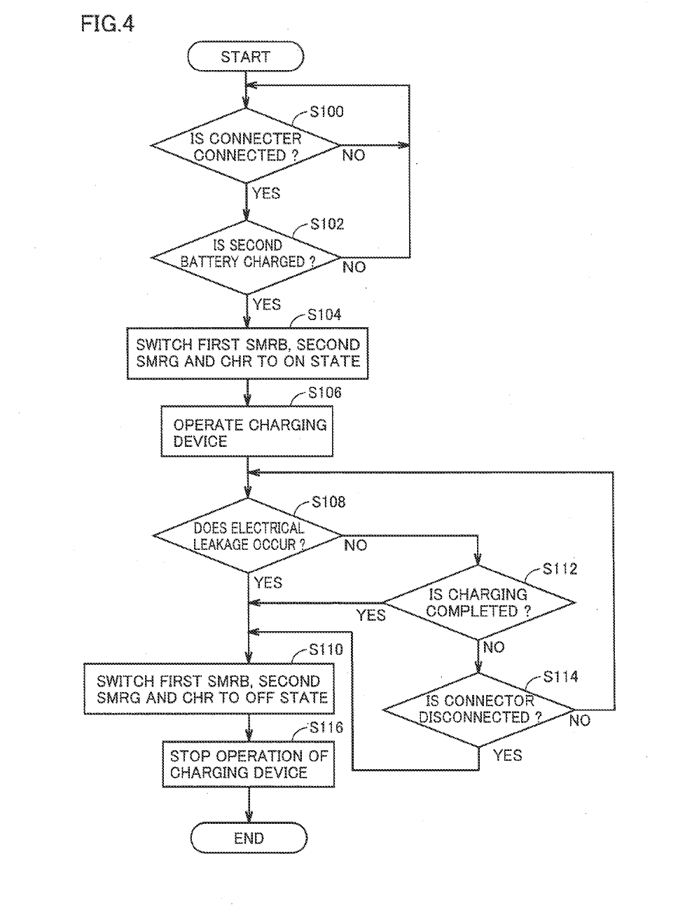

Referring to FIG. 4, the control structure of the program executed by control device 100 mounted in vehicle 1 according to the present embodiment will then be described.

In step (which will be hereinafter abbreviated as S) 100, control device 100 determines whether or not connector 702 of charging cable 700 is connected to inlet 456. When it is determined that connector 702 is connected to inlet 456 (YES in S100), the process proceeds to S102. If not (NO in S100), the process is returned to S100.

In S102, control device 100 determines whether or not second battery 60 is a target to be charged. When it is determined that second battery 60 is a target to be charged (YES in S102), the process proceeds to S104. If not (NO in S102), the process is returned to S100.

In S104, control device 100 switches each of first SMRB 54, second SMRG 66 and CHR 72 from an OFF state to an ON state. In S106, control device 100 causes charging device 450 to operate, thereby starting charging of second battery 60.

In S108, control device 100 determines whether electrical leakage occurs or not. Since the method of determining whether electrical leakage occurs or not is as described above, detailed description thereof will not be repeated. When it is determined that electrical leakage occurs (YES in S108), the process proceeds to S110. If not (NO in S108), the process proceeds to S112.

In S112, control device 100 determines whether charging is completed or not. For example, when the SOC of second battery 60 is equal to or greater than the threshold value used for determining that secondary battery 60 is in a fully-charged state, control device 100 determines that charging is completed. When it is determined that charging of second battery 60 is completed (YES in S112), the process proceeds to S110. If not (NO in S112), the process proceeds to S114.

In S114, control device 100 determines whether connector 702 is disconnected from inlet 456 or not. When connector 702 is disconnected from inlet 456 (YES in S114), the process proceeds to S110. If not (NO in S114), the process is returned to S108. In S116, the control device stops the operation of charging device 450.

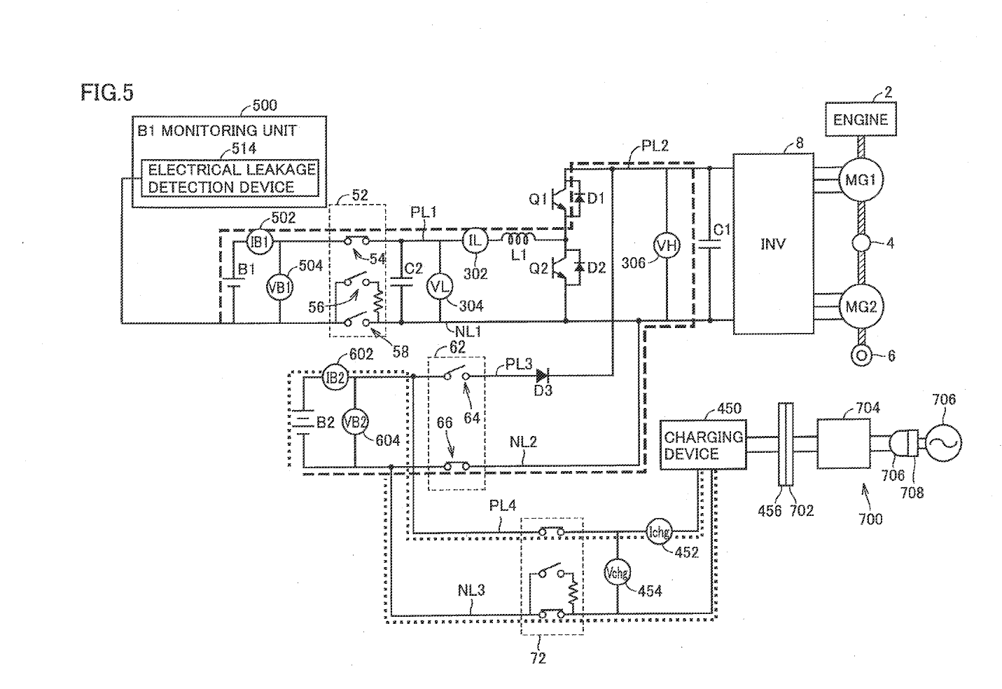

An explanation will be hereinafter given with reference to FIG. 5 with regard to the operation of control device 100 mounted in vehicle 1 in the present embodiment based on the above-described structure and flowchart.

For example, it is assumed that connector 702 of charging cable 700 is not connected to inlet 456, and each of first SMR 52, second SMR 62 and CHR 72 is in an OFF state. It is also assumed that the SOC of second battery 60 is lower than the threshold value used for determining that charging is required.

When a user connects connector 702 to inlet 456 (YES in S100), the SOC of second battery 60 is lower than the threshold value used for determining that charging is required. Accordingly, it is determined that second battery 60 is a target to be charged (YES in S102).

At this time, each of first SMRB 54, second SMRG 66 and CHR 72 is switched from an OFF state to an ON state (S104), and charging device 450 is operated (S106). Accordingly, electric power is supplied from charging device 450 to second battery 60 through the path as shown by a short dashed line in FIG. 5 (that is, the path connecting between second battery 60 and charging device 450).

Furthermore, during charging of second battery 60, it is determined based on the detection result by electrical leakage detection device 514 whether electrical leakage occurs or not (S108). At this time, by first SMRB 54 and second SMRG 66 being switched to an ON state, control device 100 determines whether electrical leakage occurs (insulation resistance Ri decreases) or not in any portion of the range shown by the path electrically connected from electrical leakage detection device 514 through positive electrode line PL1 including first battery 50, first SMRB 54 and reactor L, diode D1 of converter 10, positive electrode line PL2, capacitor C1, and negative electrode line NL2, as shown by a long dashed line in FIG. 5.

Electrical leakage occurs due to the decreased insulation resistance in any portion of the range shown in the path as described above. Accordingly, it is determined that electrical leakage occurs when peak value Vp becomes smaller than threshold value Vp(0) due to a decrease in insulation resistance Ri (YES in S108).

In this case, each of first SMRB 54, second SMR 66 and CHR 72 is switched from an ON state to an OFF state (S110), and the operation of charging device 450 is stopped (S116).

In addition, when charging is completed (YES in S112), or when connector 702 is disconnected from inlet 456 (YES in S114), each of first SMRB 54, second SMR 66 and CHR 72 is similarly switched from an ON state to an OFF state (S110), and the operation of charging device 450 is stopped (S116).

As described above, according to the power supply device of vehicle 1 in accordance with the present embodiment, when second battery 60 is charged, first SMRB 54 provided on positive electrode line PL1 and second SMRG 66 provided on negative electrode line NL2 are rendered conductive. Accordingly, it becomes possible to suppress that a voltage is applied from first battery 50 to a vehicle system including converter 10 and the electric load (inverter 8, first MG 3 and second MG 5), and also possible to use electrical leakage detection device 514 to determine whether electrical leakage occurs or not in any portion of a high-voltage path extending from first battery 50 through the converter to second battery 60. Therefore, a power supply device of a vehicle can be provided in which occurrence of electrical leakage is detected while suppressing deterioration of components in the vehicle system.

Furthermore, by switching first SMRB 54 and second SMRG 66 to an ON state, as compared with the case where first SMRB 54 and second SMRB 64 provided with diode D3 are switched to an ON state, it becomes possible to suppress that the pulse signal output from oscillation circuit 516 is blocked by the characteristics of diode D3, thereby capable of suppressing deterioration of accuracy in detecting electrical leakage by the electrical leakage detection device.

Furthermore, when connector 702 is connected to inlet 456, first SMRB 54 and second SMRG 66 are switched to an ON state, with the result that detection of electrical leakage by the electrical leakage detection device can be started at an earlier stage.

Description has been given in the present embodiment with regard to the configuration in which, when second battery 60 is charged using charging device 450, each of first SMRB 54 and second SMRG 66 is rendered conductive, and it is determined based on the detection result by electrical leakage detection device 514 whether electrical leakage occurs or not. However, for example, in the case where an electrical circuit not provided with diode D3 between first connection node a and second SMRB 64 is established, the present invention is not limited to the feature that each of first SMRB 54 and second SMRG 66 is rendered conductive.

For example, control device 100 may render one of first SMRB 54, first SMRP 56 and first SMRG 58 conductive, and render one of second SMRB 62 and second SMRG 66 conductive, thereby rendering one of electrodes of first battery 50 and one of electrodes of second battery 60 conductive. Also, based on the detection result by electrical leakage detection device 514, control device 100 may determine whether electrical leakage occurs or not.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A power supply device of a vehicle, said power supply device comprising:
a first power storage device serving as a supply source of electric power to an electric load serving as a driving source of a vehicle;
a converter converting a voltage of said first power storage device and supplying the converted voltage to said electric load;
a second power storage device connected to said electric load in parallel with said converter and serving as a supply source of electric power;
a charging device connected to said converter in parallel with said second power storage device and charging at least one of said first power storage device and said second power storage device using an external power supply of said vehicle;
an electrical leakage detection device connected to said first power storage device and detecting electrical leakage; and
a control device, when said second power storage device is charged using said charging device, causing one of electrodes of said first power storage device and one of electrodes of said second power storage device to be connected to each other, and determining based on a detection result by said electrical leakage detection device whether said electrical leakage occurs or not.

2. The power supply device of a vehicle according to claim 1, further comprising:
a first relay including a first switch provided on a first positive electrode line between said first power storage device and said converter, and a second switch provided on a first negative electrode line between said first power storage device and said converter; and
a second relay including a third switch provided on a second positive electrode line between said second power storage device and said electric load, and a fourth switch provided on a second negative electrode line between said second power storage device and said electric load, wherein
when said second power storage device is charged using said charging device, said control device renders each of said first switch and said fourth switch conductive, and determines based on the detection result by said electrical leakage detection device whether said electrical leakage occurs or not.

3. The power supply device of a vehicle according to claim 2, further comprising a diode provided on said second positive electrode line, permitting a current to flow from said second power storage device toward said electric load, and interrupting a current flowing from said electric load toward said second power storage device.

4. The power supply device of a vehicle according to claim 2, wherein, when said external power supply and said charging device are electrically connected to each other, said control device renders each of said first switch and said fourth switch conductive.

5. The power supply device of a vehicle according to claim 2, further comprising a third relay provided between said second power storage device and said charging device, wherein
when said electrical leakage is detected, said control device shuts off each of said first relay, said second relay and said third relay.

6. The power supply device of a vehicle according to claim 1, wherein
said first power storage device is a secondary battery higher in output power density than said second power storage device, and
said second power storage device is a secondary battery higher in capacity density than said first power storage device.
